(19) United States
(12) Patent Application Publication
(10) Pub. No.: US 2026/0219149 A1
(43) Pub. Date: Jul. 30, 2026

(54) PRESSURE CONTAINER TEST METHOD AND DEVICE

(71) Applicants: Hyundai Motor Company, Seoul (KR); Kia Corporation, Seoul (KR)

(72) Inventors: Gyeong Jun KIM, Hwaseong-si, Gyeonggi-do (KR); Ye Eun SHIN, Hwaseong-si, Gyeonggi-do (KR)

(21) Appl. No.: 19/143,304

(22) PCT Filed: Mar. 4, 2024
(86) PCT No.: PCT/KR2024/002723

§ 371 Date: Jun. 25, 2025

(30) Foreign Application Priority Data
Mar. 14, 2023 (KR) 10-2023-0032983

(51) Int. Cl. G01N 3/12; G01N 3/02

(52) U.S. Cl. CPC G01N 3/12; G01N 3/02

(57) ABSTRACT

A pressure container test method and a pressure container test device for a compressed hydrogen storage container are disclosed. The pressure container test method comprises the steps of: inserting a filler into the inner space of a pressure container; mounting a coupler to an opening of the pressure container having the filler inserted therein; and performing a gas test of the pressure container the inner space volume of which is reduced by the filler.

### TECHNICAL FIELD

The present disclosure relates to a testing technology for pressure containers, such as compressed hydrogen storage containers, and more particularly, to a method and apparatus for reducing time and cost in gas testing of pressure containers by using a filler.

### BACKGROUND ART

Hydrogen vehicles, or hydrogen electric vehicles, refer to zero-emission vehicles that operate using electrical energy generated from a reaction between high-pressure hydrogen stored in the vehicle and ambient air. Hydrogen electric vehicles are also referred to as fuel cell electric vehicles (FCEVs). Most hydrogen electric vehicles generate electricity through a fuel cell system that uses hydrogen as an energy source. During generating electricity in the hydrogen electric vehicles, the hydrogen electric vehicles get noticed as a future eco-friendly mobility due to not only emitting pure water (H₂O), but also removing ultrafine dust particles from the atmosphere during operation. Due to the abundance of hydrogen on Earth and the environmentally friendly nature of the energy generation process, this technology is gaining widespread attention for its potential applications across various industries.

Hydrogen-fueled mobility refers to a mobility that uses hydrogen either as a direct fuel or as an energy source to generate electricity, which is then used to drive an electric motor. Aside from the hydrogen electric vehicles, the hydrogen-fueled mobility includes aerial mobility, industrial trucks, trains, ships, and aircraft, encompassing all devices that operate by generating electricity from hydrogen fuel.

Most hydrogen electric vehicles generate electricity by electrochemical reaction between oxygen and hydrogen in a fuel cell stack, the oxygen being provided by an air providing system and the hydrogen being provided by a hydrogen fuel storage tank. The generated electricity is then converted into kinetic energy by a drive motor to propel the vehicle, and preferably, only pure water is emitted from the exhaust outlet during driving.

Meanwhile, the concept of a hydrogen-fueled car, distinct from hydrogen electric vehicles, refers to vehicles that directly combust hydrogen in an internal combustion engine (ICE) to generate thermal energy, which then drives an electric motor. The method for refueling hydrogen-fueled cars is largely similar to that of hydrogen electric vehicles.

Meanwhile, in hydrogen storage systems, such as compressed hydrogen storage systems (CHSS) and liquefied hydrogen storage systems (LHSS), which are installed or mounted on vehicles or equipment that use hydrogen as fuel, it is necessary to evaluate the performance of the pressure containers for safety and reliability. Currently, as testing procedures for pressure container performance, hydrostatic cyclic testing and pressure cycling tests ae used. These tests are typically conducted over long durations, for example, at least 1,000 hours, under various pre-set temperature conditions.

Accordingly, conventional performance testing of pressure containers is highly inefficient due to the long testing times required, which result in extremely high costs.

### DISCLOSURE

### Technical Problem

An object of the present disclosure is to provide a pressure container test method capable of significantly reducing gas testing time of a pressure container used in hydrogen storage systems and the like, by using a filler to reduce the internal volume of the pressure container.

Another object of the present disclosure is to provide a pressure container test device for the aforementioned pressure container test method.

### Technical Solution

According to an exemplary embodiment of the present disclosure, a method for testing a pressure container for compressed hydrogen storage, may comprise: inserting at least one filler into an internal space of a pressure container; mounting a coupler to an opening of the pressure container in which the filler is inserted; and performing a gas test on the pressure container in which the internal space is reduced in volume by the filler.

According to another exemplary embodiment of the present disclosure, a pressure container test device for testing a compressed hydrogen storage container may comprise: at least one processor, wherein the at least one processor may cause the pressure container test device to perform: inserting a filler into an internal space of a pressure container; mounting a coupler to an opening of the pressure container in which the filler is inserted; and performing a gas test on the pressure container in which the internal space is reduced in volume by the filler.

The filler may have a second length that corresponds to a first length of the internal space in a longitudinal direction of the pressure container and is smaller than the first length.

In the inserting of the filler, the processor may cause the pressure container test device to insert a predetermined number of fillers so as to occupy 20% to 50% of the internal volume of the pressure container.

In the testing of the gas, a pressure cycling test may be performed at ambient and extreme temperatures.

The processor may further cause the pressure container test device to perform measuring the specifications of the pressure container.

The processor may further cause the pressure container test device to determine at least one of the type and quantity of the fillers according to the specifications.

The processor may further cause the pressure container test device to perform transporting the pressure container to a position for filler insertion.

The processor may further cause the pressure container test device to perform fixing the pressure container before inserting the filler.

The processor may further cause the pressure container test device to perform detaching the coupler from the pressure container before inserting the filler.

The coupler may include a check valve, a shut-off valve, and a thermally activated pressure relief device.

### Advantageous Effects

According to the present disclosure, by using a filler to reduce the internal volume of the pressure container, a time required for the gas testing on the pressure container may be significantly shortened, thereby meaningfully reducing the time and cost required for pressure container testing.

### DESCRIPTION OF DRAWINGS

FIG. 1 is a conceptual diagram of a pressure container test device performing a pressure container test method according to an exemplary embodiment of the present disclosure.

FIG. 2 is a flowchart illustrating main procedures of the pressure container test method according to an exemplary embodiment of the present disclosure.

FIG. 3 is a cross-sectional view showing interior of the pressure container before inserting a filler in FIG. 2.

FIG. 4 is a cross-sectional view showing interior of the pressure container after inserting a filler in FIG. 2.

FIG. 5 is a plan view for describing a filler that may be employed in the method of FIG. 2.

FIG. 6 is a view for describing cross-sectional shapes applicable to the filler shown in FIG. 5.

FIG. 7 is a partial plan view for describing a structure applicable to the filler of FIG. 5.

FIG. 8 is another partial plan view for describing a different structure applicable to the filler of FIG. 5.

FIG. 9 is a schematic perspective view for describing a pressure container to which the method of FIG. 2 may be applied.

FIG. 10 is a partially cut-out perspective view of another pressure container to which the method of FIG. 2 may be applied.

FIGS. 11 to 14 are conceptual diagrams of still another pressure containers to which the method of FIG. 2 may be applied.

FIG. 15 is a perspective view for describing a filler insertion device that may be employed in the pressure container test device of FIG. 1.

FIG. 16 is a perspective view for describing a coupler mounting device that may be employed in the pressure container test device of FIG. 1.

FIG. 17 is a flowchart of another pressure container test method according to another exemplary embodiment of the present disclosure.

FIG. 18 is a view showing results in which the testing time of the pressure container test method according to the present exemplary embodiment and that of a conventional pressure container test method are compared.

FIG. 19 is a schematic block diagram of a pressure container test device according to another exemplary embodiment of the present disclosure.

### BEST MODE OF THE DISCLOSURE

In addition to the above objects, another objects and features of the present disclosure will become more apparent through the description of exemplary embodiments with reference to the accompanying drawings.

For a clearer understanding of the features and advantages of the present disclosure, exemplary embodiments of the present disclosure will be described in detail with reference to the accompanied drawings. However, it should be understood that the present disclosure is not limited to particular embodiments disclosed herein but includes all modifications, equivalents, and alternatives falling within the spirit and scope of the present disclosure.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” may include a presence of one or more of the associated listed items and any and all combinations of the listed items.

In the description of exemplary embodiments of the present disclosure, “at least one of A and B” may mean “at least one of A or B” or “at least one of combinations of one or more of A and B”. In addition, in the description of exemplary embodiments of the present disclosure, “one or more of A and B” may mean “one or more of A or B” or “one or more of combinations of one or more of A and B”.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

The definitions of certain terms used in this specification are as follows.

The Hydrogen fueled mobilities generally include not only the hydrogen electric vehicles or hydrogen fuel cell electric vehicles (FCEVs) using the fuel cells but also the internal combustion engine (ICE)-based vehicles using the hydrogen as fuel.

Although the exemplary embodiments below describe a fuel cell electric vehicle as the main example, other exemplary embodiments of the present disclosure may include hydrogen electric vehicles based on ICE using hydrogen as fuel. In the exemplary embodiments described below, hydrogen fueling protocols and/or communication protocols for hydrogen fuel supply are disclosed with a focus on fuel cell electric vehicles, and according to other exemplary embodiments of the present disclosure, the hydrogen fuel supply protocol and/or communication protocol disclosed in the exemplary embodiments below may also be applied to ICE-based hydrogen electric vehicles. Hydrogen fuel may include gaseous hydrogen fuel or liquid hydrogen fuel.

A compressed hydrogen storage system (CHSS) may refer to at least one tank mounted on the vehicle and a device coupled to the tank to compress and store hydrogen in the tank.

Dry hydrogen may refer to hydrogen that meets or exceeds the quality level defined in ISO 14687.

A fold may refer to a location where different materials meet.

‘Full-wrapped’ may refer to a case of being reinforced entire portion of a liner, the entire portion including a dome and a cylindrical portion, with composite material.

‘Hoop-wrapped’ may refer to a case of being reinforced only a cylindrical portion of a liner (not a dome) with a circumferential pattern so that stress is not transferred in a direction parallel to the longitudinal axis of the container.

Leak test gas may refer to gas used for leak testing, which consists of dry hydrogen, dry helium, or a detectable mixture thereof.

A liner may refer to an inner container or a gas container to which an overwrap is applied.

Maximum fueling pressure (MFP) may refer to the maximum pressure applied to the compression system during fuel charging and may correspond to 125% of the nominal working pressure. The nominal working pressure may refer to the pressure of the container specified by the container manufacturer when the container is fully charged at 15° C.

Minimum required burst pressure may refer to the minimum burst pressure required to demonstrate the stress ratio during a burst test.

Permeation refers to phenomenon in which gas inside the container diffuses to the outside without defects or cracks.

Fill pressure may refer to pressure maintained by charging.

Hydraulic pressure may refer to pressure applied to the container during a certification test using test gas or other gases as described in this specification.

A thermally-activated pressure relief device (TPRD) may refer to a device that, when installed in a pressure container, releases the contents of the container to the outside when the temperature of the container exceeds a preset temperature.

Rupture may refer to phenomenon where damage to the container progresses rapidly, causing the container to break.

In the following description, hydrogen fuel may include at least one of hydrogen in a gaseous state and hydrogen in a liquid state and generally refers to compressed hydrogen, although not limited thereto.

Even known technologies prior to the filing date of the present disclosure may be included as part of the configuration of the present disclosure if necessary, and such will be described herein within the scope that does not detract from the spirit of the present disclosure. However, in describing the configuration of the present disclosure, a detailed description of prior art that is self-evident to those skilled in the art may be omitted as it may detract from the spirit of the present disclosure. Furthermore, the present disclosure does not intend to claim rights to these known technologies, and the contents of the known technologies may be included as part of the present disclosure within a scope that does not depart from the spirit of the present disclosure.

For example, in the case of one-way communication, IrDA (infrared data association) technology may be used; for two-way communication, short-range wireless communication technologies such as Bluetooth, WLAN (wireless local area network), and UWB (ultra-wide band) may be used; or wired communication technologies for one-way/two-way communication may be used, and these known technologies may be applied as component technologies necessary to implement the present disclosure.

Hereinafter, preferred exemplary embodiments of the present disclosure will be described in detail with reference to the accompanying drawings.

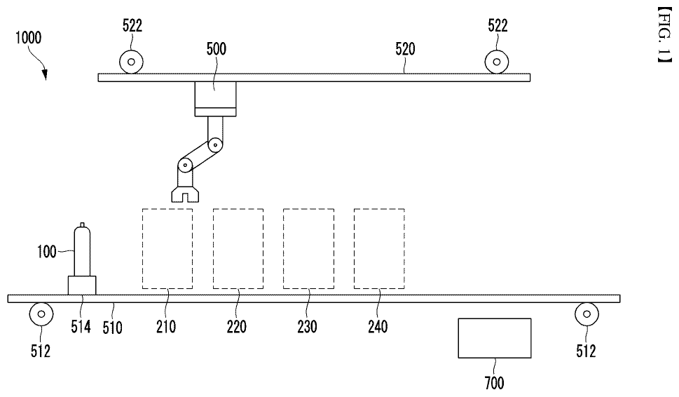

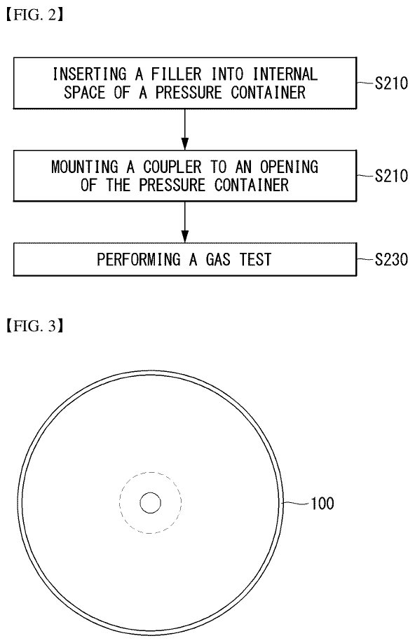

FIG. 1 is a conceptual diagram of a pressure container test device performing a pressure container test method according to an exemplary embodiment of the present disclosure. FIG. 2 is a flowchart illustrating main procedures of the pressure container test method according to an exemplary embodiment of the present disclosure.

As shown in FIG. 1, a pressure container test facility (hereinafter briefly referred to as the ‘test facility’) 1000 may include facilities (see 210, 220, 230, 240) for performing gas tests on the pressure container 100, and at least one robot 500. The facilities may include a filler insertion device 210, a coupler mounting device 220, a gas test device 230, and an inspection device 240. The robot 500 may include a robot arm.

In addition, the test facility 1000 may further include a pressure container transfer device, a robot transfer device, and a control device 700. The pressure container transfer device may have a belt conveyor form including a belt 510, pulley 512, rollers, etc., and the robot transfer device may have a transfer rail structure including a rail 520, an actuator 522, etc.

The test facility 1000 may perform the pressure container test method (hereinafter briefly referred to as the ‘test method’) according to exemplary embodiments. The test method may perform main procedures while the pressure container 100, which is the object of performance measurement of the gas test, is placed on the belt 510 of the conveyor transfer device. As shown in FIG. 2, the main procedures may include a series of steps such as inserting a filler into the pressure container (S210), mounting a coupler on the pressure container (S220), and performing a gas test on the pressure container with reduced internal volume due to the inserted filler (S230).

The aforementioned gas test may refer to a performance test or a quality test of the pressure container 100. For example, the quality test may include an ambient and extreme temperature gas pressure cycling test. Also, the main gas tests may include a leak test, permeation test, and pressure cycling test.

Such gas tests may be performed according to test procedures specified in the GTR (Global Technical Regulation) NO. 13 standard, Regulation No. 134 of the Economic Commission for Europe of the United Nations (UN/ECE), or SAE (Society of Automotive Engineers) J2579 standard.

Gas tests for the pressure container 100 may take a long time, such as several months to one year, and cost hundreds of millions of dollars.

The basic test procedures of the above-mentioned GTR NO. 13 and SAE J2579 are shown in Table 1 below.

TABLE 1

| | GTR No. 13 | SAE J2579 |
|---|---|---|
| Number of | 500 cycles, 1^{st} + 2^{nd} Group | 500 cycles for light-duty, |
| repetitions | | 1^{st} + 2^{nd} Group |
| Hydrogen gas | ≤−40° C. | ≤−35° C. |
| temperature | | |
| Environmental | Minimum 24 h | minimum 24 h |
| stabilization | | |
| time | | |
| pressure | 20(+0/−10)bar up to target | 20(+0/−10)bar to target |
| | pressure(±10) | pressure |
| Filling speed | 3 min ramp, <60 g/s | Maintain exhaust velocity |
| | | (provided by manufacturer) |

In this exemplary embodiment,
the testing equipment is configured to perform a gas test on the pressure container after inserting fillers into the pressure container to reduce the internal volume thereof, in addition to the aforementioned basic testing procedures. According to this configuration, it is possible to conduct gas tests on pressure containers having a relatively small internal volume, and thereby significantly shorten the gas testing time of the corresponding pressure container compared to conventional methods.

In addition, ISO (International Organization for Standardization) Standard 19881 stipulates testing procedures for “Gaseous hydrogen-Land vehicle fuel containers” as follows.

That is, according to ISO 19881, containers should be capable of cycling pressure up to 125% of nominal working pressure for 1,000 cycles using hydrogen stored at 2 MPa±1 MPa. A boss at a valve end, where filling or discharge occurs, may be grounded. Each cycle consists of filling and discharging the container. The filling rate shall not exceed 60 g/s and a maximum allowable gas temperature shall not be exceeded. The discharge rate must be specified by a container manufacturer. First 500 cycles should be conducted at ambient temperature, followed by a static hold at 115% of nominal working pressure (±1 MPa) at 55° C. for at least 30 hours. The second 500 cycles should be conducted using 250 cycles at −30° C. and 250 cycles at 50° C.

In the test method of the exemplary embodiments, in addition to the basic testing procedures in accordance with the above ISO 19881 standard, fillers are inserted into the pressure container to reduce the internal volume of the container before conducting the gas test. According to this configuration, when compared to the gas test time required by the basic procedures under ISO 19881, similar gas test results may be obtained using a subscale pressure container with a reduced diameter of up to 20% and a reduced length of up to 50%. That is, the gas test time may be significantly reduced by more than half, compared to the basic procedure under ISO 19881.

Furthermore, ISO/FDIS 19884 stipulates the use of subscale devices for testing “Gaseous hydrogen-Cylinders and tubes for stationary storage.” That is, according to ISO/FDIS 19884, the test may be performed on a smaller pressure container with a shorter length than the actual full-scale container. The length-to-diameter (L/D) ratio of the small-scale pressure container must be greater than 2.5. If the L/D ratio of the full-scale cylinder-type pressure container is less than 2.5, then the test must be performed on the full-scale cylinder-type container. The winding pattern of the small-scale cylinders and tubes must be the same as that of the full-scale container.

In this exemplary embodiment's test method, in addition to the basic test procedure under the ISO/FDIS 19884 standard, the test is carried out with fillers inserted to reduce the internal volume of the pressure container. According to this configuration, when compared to the gas test time required by ISO 19884 standard procedures, similar testing effects may be obtained even when using full-scale pressure containers by employing fillers to reduce internal volume. Thus, the time and cost required for gas testing of pressure containers may be significantly reduced.

Referring again to FIG. 1, the gas test procedure for the pressure container according to the present exemplary embodiments will be described in more detail. The pressure container 100 may be transported to a filler insertion device 210 by the belt 510 of a pressure container transfer device, which is fastened to the belt 510 by a support device 514. The filler insertion device 210 may include a fixing unit and an insertion unit. When the pressure container 100 is fixed by the fixing unit, the insertion device may insert pre-prepared fillers into the interior of the pressure container 100. The fixing device may also be referred to as a support unit, and the insertion device may be referred to as a filler insertion unit.

The insertion device may insert the fillers into the interior of the pressure container 100. The fillers may be inserted such that the fillers occupy 20% to 50%, and more preferably 35% to 45%, of the internal volume of the pressure container 100. The insertion device may repeatedly perform insertion operations depending on the number N of fillers.

If the filler insertion is performed for less than 20% of the internal volume, the reduction in internal volume may be trivial. If the filler insertion exceeds 50% of the internal volume, it may be difficult to ensure the reliability of the quality test of the pressure container. That is, the fillers are inserted into a narrow central boss region of the pressure container 100. Therefore, if the fillers occupy more than 50% of the internal volume, workability may be degraded during the insertion or removal process. Thus, it is preferable that the filler insertion be performed in a range that occupies about 20% to 50% of the internal volume of the pressure container 100, achieving a reduction in volume without significantly impairing workability. Furthermore, depending on the type or size of the pressure container, slight variations may exist, but considering the effect of shortening the gas test time, it is most preferable for the fillers to occupy about 40% of the internal volume.

The above-described fixing device or insertion device may be implemented by at least one robot 500 having at least one robot arm.

Next, when the desired number of fillers are inserted into the pressure container 100, a coupler mounting device 220 may mount a coupler to the opening of the pressure container 100. The coupler may include a check valve, a shut-off valve, and a thermally-activated pressure relief device (TPRD). A boss may be arranged between the opening and the coupler. The boss may be integrally formed with the coupler and have a detachable structure at the opening of the pressure container 100, for example, a threaded structure.

The opening of the pressure container 100 may be an open inlet transferred without the coupler mounted, or may be an open inlet where the coupler was removed after transfer with the coupler mounted, in consideration of the filler insertion.

The above-described coupler mounting device 220 may also be implemented by at least one robot 500 having at least one robot arm.

Next, when the fillers are inserted and the coupler is mounted to the opening so that the pressure container 100 is in a state capable of gas charging, a gas test device 230 may test the performance of the pressure container 100 according to a predetermined gas test procedure.

Next, an inspection device 240 may inspect the state of the pressure container 100 during or after the gas test performed by the gas test device 230, or compare the states before and after the test. For example, the inspection device 240 may inspect for leakage under a pressure atmosphere of 10 MPa to 87.5 MPa; measure a first permeation rate at a high temperature atmosphere (e.g., 55° C.); perform repeated pressure cycling tests in ambient temperature (e.g., 20±5° C.), high temperature (e.g., 55° C.), and low temperature (e.g., −40° C.) atmospheres; then measure a second permeation rate again at high temperature (e.g., 55° C.); perform 5,000 cycles of pressure cycling at 125% of the nominal working pressure (NWP) in ambient temperature (e.g., 20° C.), and then measure a third permeation rate at high temperature (e.g., 55° C.) to inspect the durability of the pressure container.

As described above, by using the gas test device 230 and inspection device 240, the durability of the pressure container 100 may be effectively verified through pressurized cycling tests using gas. In particular, by reducing the internal volume through the use of fillers in the pressure container 100, the time required for durability testing may be significantly shortened.

In the present exemplary embodiment, the robot 500 refers to a mechanical device that automatically performs predetermined tasks or operations, and may include or be replaced by at least one means for fixing the pressure container, inserting fillers into the pressure container, and mounting a coupler to one end opening of the pressure container, or a component performing equivalent functions. Such a robot 500 may be configured as an articulated robot, transport robot, assembly robot, industrial robot, or a combination thereof.

Furthermore, in this exemplary embodiment, the control device 700 may be configured to control operations of the filler insertion device 210, the coupler mounting device 220, the gas test device 230, the inspection device 240, the robot 500, and transfer devices. The control device 700 may include at least one sub-control device installed in at least one of the filler insertion device 210, the coupler mounting device 220, the gas test device 230, the inspection device 240, the robot 500, and transfer devices, and a main control device connected via wired or wireless network to control or interlock with the at least one of sub-control device. The control device 700 may be coupled with a communication module, a user interface device, a storage device, etc., and such a combination may be referred to as a computing system.

FIG. 3 is a cross-sectional view showing interior of the pressure container before inserting a filler in FIG. 2. FIG. 4 is a cross-sectional view showing interior of the pressure container after inserting a filler in FIG. 2.

As shown in FIG. 3, the pressure container 100 to which the test method is applied may be in an empty state prior to the insertion of the fillers.

On the other hand, as shown in FIG. 4, when the filler insertion step is performed as part of the test procedure, a plurality of fillers 300 may be inserted into the internal space of the pressure container 100, thereby reducing the volume of the internal space of the pressure container 100 by a certain amount.

In this exemplary embodiment, the filler 300 may be used to occupy approximately 20% to 50% of the internal volume of the pressure container 100.

By using the aforementioned filler 300, the actual-size pressure container 100 may function as if it were a smaller-sized container during gas testing, effectively contributing to a reduction in gas test time.

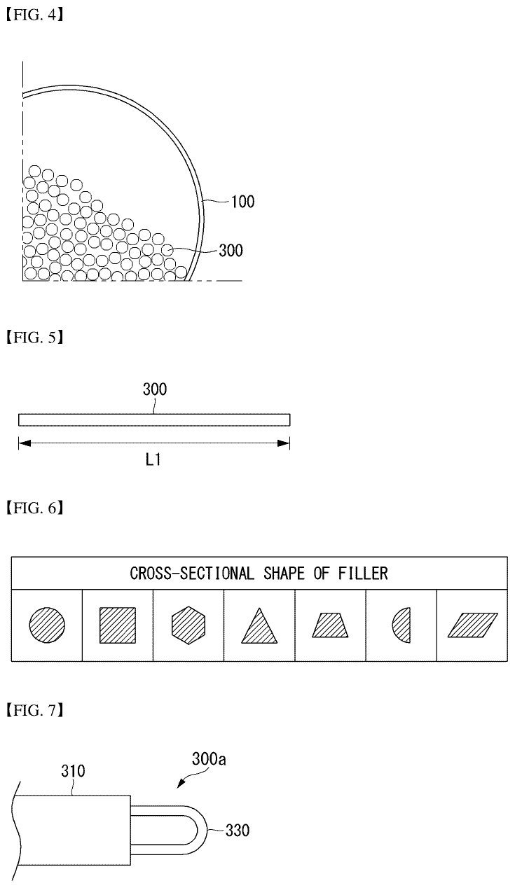

FIG. 5 is a plan view for describing a filler that may be employed in the method of FIG. 2. FIG. 6 is a view for describing cross-sectional shapes applicable to the filler shown in FIG. 5.

As shown in FIG. 5, the filler 300 may have a predetermined length L1 and a predetermined diameter. The diameter is smaller than that of the opening of the pressure container, allowing the filler 300 to be completely inserted through the opening into the internal space of the pressure container. The length L1 is also smaller than the length of the internal space of the pressure container.

A cross-sectional shape of such a filler 300 may be circular, semi-circular, rectangular, triangular, isosceles triangular, parallelogram, rhombus, hexagonal, polygonal, or of any arbitrary shape, as shown in FIG. 6.

The material of the filler 300 may be formed from low-density polyethylene, high-density polyethylene, synthetic resin, metallic material, composite material, etc. The material of the filler 300 may be selected arbitrarily, as long as the material has sufficient durability not to be damaged during gas testing of the pressure container (e.g., gas leak test, burst test, repeated pressure test, gas permeability test) and may be manufactured in a rod-like shape that may be inserted into the interior of the pressure container.

FIG. 7 is a partial plan view for describing a structure applicable to the filler of FIG. 5.

As shown in FIG. 7, a filler 300a according to the present exemplary embodiment may include a body 310 and a hook 330 provided at one end of the body 310. The body 310 may have the basic filler shape described above with reference to FIGS. 5 and 6. The body 310 may also be referred to as a filler body.

The hook 330 may be provided at one or both ends of the body 310 in the longitudinal direction. The hook 330 may function so that the filler 300a, while being inserted into the pressure container, is transported in a state where the filler 300a is detachably hung on the distal end of an arm (referred to hereinafter as a “mechanical arm”) driven by a robot arm or actuator of the filler insertion device. Furthermore, when extracting the filler 300a from the interior of the pressure container, the hook 330 may be hooked by a robot arm or mechanical arm and withdrawn from the internal space of the pressure container according to the movement of the robot or mechanical arm.

FIG. 8 is another partial plan view for describing a different structure applicable to the filler of FIG. 5.

As shown in FIG. 8, the filler 300b according to present exemplary embodiment may include a body (refer to 310 in FIG. 7) and a hook 330 provided at one end of the body. The body may have the basic filler shape described above with reference to FIGS. 5 and 6. Additionally, the body may be configured to exhibit different magnetic polarities on both sides along a width direction. For example, the body may include a first part 310a representing a positive pole and a second part 310b representing a negative pole. The hook 330 is substantially the same as the hook of the filler shown in FIG. 7, and thus a detailed description will be omitted.

According to the configuration of the above-described filler 300b, the fillers inserted into the internal space of the pressure container may be positioned together like a single mass due to the attractive force between magnetic materials. When such fillers are used, the internal volume of the pressure container may be more clearly reduced during gas testing, contributing to a reliable shortening of gas test time.

On the other hand, when using magnetic fillers 300b, insertion or removal of the fillers may be hindered by magnetic attraction between the fillers. To prevent this, the filler of the present exemplary embodiment may have a magnetic force strength that is appropriately controlled. In addition, to prevent such interference, the filler insertion device of the present exemplary embodiment may be configured to extract the fillers by rotating or vibrating them during the removal process from the interior of the pressure container.

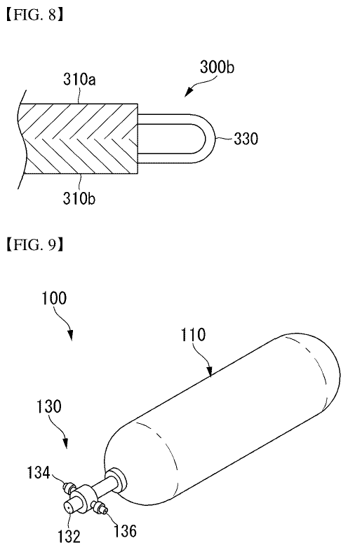

FIG. 9 is a schematic perspective view for describing a pressure container to which the method of FIG. 2 may be applied.

As shown in FIG. 9, the pressure container 100 may include a container body 110 having an internal space and a coupler 130 coupled to an opening of the container body 110.

The pressure container 100 may be configured to store compressed natural gas, compressed hydrogen gas, hydrogen gas, renewable natural gas, and the like. The pressure container 100 may be configured to store hydrogen at a nominal working pressure of 35 MPa or 70 MPa when used in vehicles and the like.

Furthermore, the pressure container 100 may be configured to withstand a maximum fueling pressure that is 125% of the nominal working pressure, i.e., 43.8 MPa or 87.5 MPa respectively. This is because, during the typical “fast filling” fueling process, adiabatic compression of gas causes heating within the pressure container 100, potentially increasing the internal pressure up to 25% above the nominal pressure.

The container body 110 may have a cylindrical or tubular shape with an internal space. The material of the container body 110 may be metal, aluminum alloy, or a composite material. The composite material may include polyethylene/clay nanocomposite liner, carbon fiber composite material, glass fiber composite material, impact damage resistant foam, or combinations thereof. The container body 110 may be wrapped by a wrapping material so that the body, excluding the dome, or the entire container including the dome and the body has at least a dual-layer structure.

The coupler 130 may include a check valve 132, a shut-off valve 134, and a thermally-activated pressure relief device (TPRD) 136.

The check valve 132 may allow fuel such as hydrogen in the fuel supply line to flow into the container body 110 and prevent backflow of the fuel from the container body 110 to the supply line.

The shut-off valve 134 prevents leakage of stored hydrogen when a device (e.g., a vehicle) using hydrogen fuel is not in operation or when a fault requiring isolation is detected.

The TPRD 136 may release gas from inside the container when a fire occurs in a vehicle equipped with the pressure container 100, before dangerous rupture due to weakening of the container from high temperature. The TPRD 136 may be designed to quickly release the entire contents of the container.

The above-described container body 110 or the pressure container 100 may be referred to as a storage vessel or a storage container, or simply a chamber, a vessel, or container.

For example, the container may be manufactured from a composite material to store a sufficient mass of hydrogen at high pressure for use in vehicles. Most high-pressure hydrogen storage containers used in fuel cell or ICE vehicles may be composed of two layers: an internal liner and an outer liner. The internal liner may be made of metal or thermoplastic polymer capable of preventing gas leakage or permeation. The outer liner may provide structural integrity and may be made of metal or a fiber-reinforced composite impregnated with thermosetting resin that wraps the internal liner. The internal liner may simply be referred to as the liner, and the outer liner may be referred to as the wrapping material surrounding the liner.

Furthermore, the pressure container 100 may include non-pressure-bearing components for additional support and/or protection when used in vehicles.

Additionally, the pressure container 100 may be classified into Types 1 through 4 based on its structure. Type 1 refers to a metal container. Type 2 refers to a hoop-wrapped container with a metal liner and a composite material wrapping only a cylindrical portion of the metal liner. Type 3 refers to a full-wrapped container with a metal liner and a composite material wrapping entire portion of the container (dome and body). Type 4 refers to a container with a non-metallic liner and a composite material wrapping entire portion of the non-metallic liner.

The pressure container of Type 3 or Type 4 may be used as a high-pressure hydrogen container. Type 3 containers are made by wrapping carbon fiber in circumferential and longitudinal directions over a metal liner such as aluminum liner, where the metal liner bears little or no load. Type 4 containers are designed to be lightweight by wrapping carbon fiber over a non-metallic liner in both circumferential and longitudinal directions. The non-metallic liner is configured to serve only as a gas barrier, bearing almost no structural load.

Hydrogen vehicles, such as hydrogen electric vehicles or fuel cell hydrogen vehicles, use Type 4 pressure containers. The liner of hydrogen vehicles is made of high-density polyethylene (HDPE), which is a non-metallic material with low gas permeability. To compensate for the lower gas barrier properties compared to metallic materials, the HDPE liner may be thicker than Type 3 liners.

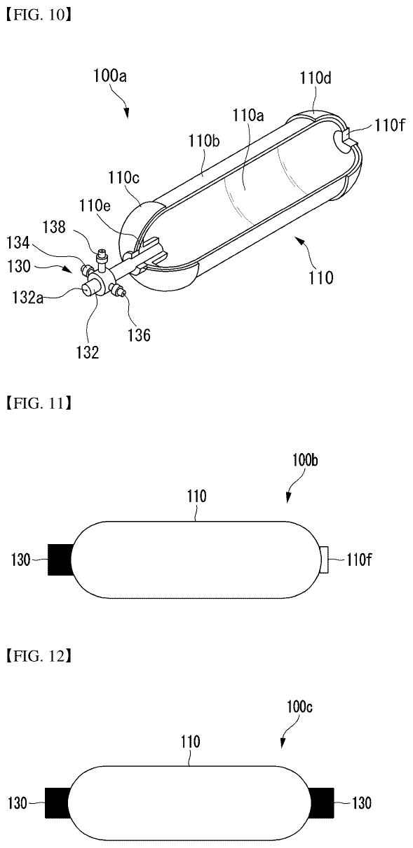

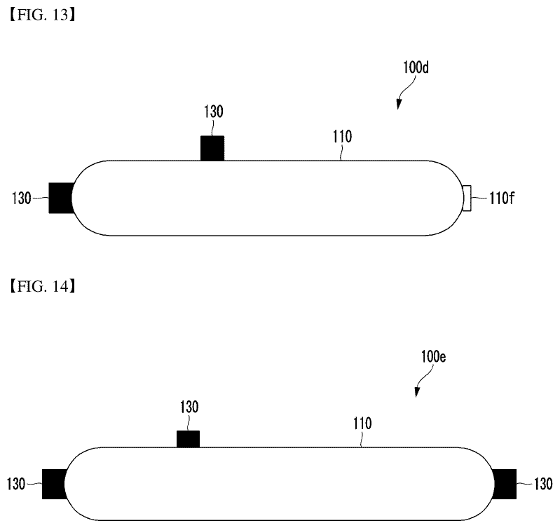

FIG. 10 is a partially cut-out perspective view of another pressure container to which the method of FIG. 2 may be applied.

As shown in FIG. 10, the pressure container 100a may include a high-density polymer liner 110a, a carbon fiber composite material 110b, an upper container protection cover 110c, a lower container protection cover 110d, a first boss 110e, a second boss 110f and a coupler 130.

The container body 110 of the pressure container 100a may include the high-density polymer liner 110a corresponding to an inner liner, the carbon fiber composite material 110b corresponding to an outer liner, the upper container protection cover 110c, the lower container protection cover 110d, the first boss 110e, and the second boss 110f.

The upper and lower container protection covers 110c and 110d may be installed to protect the pressure container 100a. The lower protection cover 110d may include at least one of a handle or groove to facilitate replacement, transport, mounting, or support of the pressure container 100a.

The first boss 110e is installed at a first opening of the container body, where the coupler 130 is connected to the pressure container 100a. The first boss 110e may be disposed between the opening of the container body and the coupler 130, and may be coupled with one end of the coupler 130 through a screw thread connection. The second boss 110f is installed to close the second opening of the container body, located on the opposite side of the first opening. The second opening may be formed during the manufacturing of the cylindrical or tubular container body.

The coupler 130 in this exemplary embodiment may include a check valve 132, a shut-off valve 134, a TPRD 136, and a pressure sensor 138. The check valve 132 may function as the hydrogen charging port and may include a hydrogen inlet 132a. The shut-off valve 134 may function as a hydrogen discharge port and include a hydrogen outlet.

The pressure sensor 138 may be installed to measure and display the internal pressure of the pressure container 100a.

FIGS. 11 to 14 are conceptual diagrams of still another pressure containers to which the method of FIG. 2 may be applied.

As shown in FIG. 11, a pressure container 100b may have a structure or configuration similar to the pressure container previously described with reference to FIG. 9, comprising a container body 110, a coupler 130 attached to one end in the longitudinal direction of the container body 110, and a boss 110f attached to an opposite end.

As shown in FIG. 12, a pressure container 100c may have a structure or configuration comprising a container body 110 and two couplers 130 respectively attached to both longitudinal ends of the container body 110.

As shown in FIG. 13, a pressure container 100d may have a structure or configuration comprising a container body 110, a coupler 130 attached to one longitudinal end of the container body 110, and another coupler 130 installed in the middle of the container body 110 along the longitudinal direction.

As shown in FIG. 14, a pressure container 100e may have a structure or configuration comprising a container body 110, a pair of couplers 130 respectively attached to both longitudinal ends of the container body 110, and another coupler 130 installed in a middle of the container body 110 along the longitudinal direction.

At least one of the couplers 130 in each of the pressure containers 100b, 100c, 100d, and 100e may have the same function or structure as the coupler described with reference to FIG. 9 or 10.

In addition, the gas test for each of the pressure containers 100b, 100c, 100d, and 100e according to the above-described exemplary embodiments may be performed in a state where a filler is inserted into one longitudinal end of the container to reduce the internal volume.

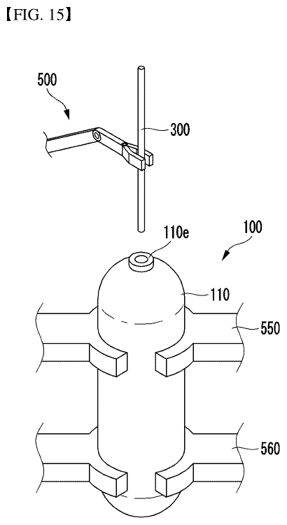

FIG. 15 is a perspective view for describing a filler insertion device that may be employed in the pressure container test device of FIG. 1.

As shown in FIG. 15, the filler insertion device may include a first support device 550, a second support device 560, and a robot 500. The first and second support devices 550 and 560 may be replaced by a single support device. The robot 500 may include a robot arm.

The filler insertion device may insert filler 300 through the opening of the pressure container 100 after the pressure container 100 is transported to a predetermined position and is fixed by the support device. At the edge of the opening of the pressure container 100, a boss 110e for later coupling of the coupler may be exposed. That is, the filler insertion device may pick up pre-prepared filler 300 with the robot 500 and insert the pre-prepared filler 300 into the internal space of the pressure container 100 through the opening.

The filler insertion device may operate to insert a predetermined number of fillers 300, selected based on the measured specifications of the pressure container 100. The specifications of the pressure container 100 may include at least one of length, diameter, or internal volume. Once a certain number of fillers are inserted into the internal space of the pressure container 100, the internal volume of the pressure container 100 may be reduced, for example, by about 40%.

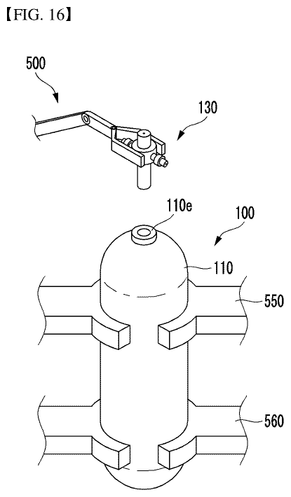

FIG. 16 is a perspective view for describing a coupler mounting device that may be employed in the pressure container test device of FIG. 1.

As shown in FIG. 16, the coupler mounting device may mount a coupler 130 to an opening of the pressure container 100. That is, once a predetermined number of fillers of a given size are inserted into the pressure container by the filler insertion device, the coupler mounting device may pick up a pre-prepared coupler 130 using the robot 500 and attach the pre-prepared coupler 130 to the opening.

Although not explicitly shown in the figure, the robot 500 may be configured to rotate the coupler 130 so that the coupler 130 engages with the opening of the pressure container 100 by a screw thread connection.

FIG. 17 is a flowchart of another pressure container test method according to another exemplary embodiment of the present disclosure.

As shown in FIG. 17, the pressure container test method may be performed by the pressure container test device previously described with reference to FIG. 1. The pressure container test device may also be broadly referred to as a pressure container test apparatus. This pressure container test device may include a control device, a specification measurement device, a coupler removal device, a filler insertion device, a coupler mounting device, a gas test device, and an inspection device.

The specification measurement device may measure the specifications of the pressure container (S171). The specifications of the pressure container may include length, diameter, capacity, and type. The specification measurement device may be controlled by the control device. The specification measurement device may be easily implemented using at least one existing measurement device that measures length and weight and acquires displayed or stored information.

Next, the control device may determine the type and quantity of fillers to be inserted into the pressure container based on the specifications measured by the specification measurement device (S172).

Then, when the pressure container is transported to a predetermined location, the pressure container may be fixed by the support device, and the coupler removal device may remove the coupler from the pressure container (S173). If the pressure container is transported without the coupler attached, the coupler removal step may be omitted.

Once the pressure container is fixed at the designated location (S174), the filler insertion device may insert fillers into the pressure container (S175). The filler insertion device may insert the fillers into the interior of the pressure container based on the type and quantity of fillers delivered from the control device. Depending on the size of the fillers, a specified number of fillers may be inserted simultaneously.

The filler insertion device may be configured to feed fillers stored in a filler storage device to the opening of the pressure container via a predetermined guide path and/or rail under the control of the control device.

Then, the coupler mounting device may mount the coupler to the opening of the pressure container (S176). The coupler mounting device may be configured to position the coupler near the opening and, while holding the coupler in place, rotate the pressure container beneath the coupler to engage the coupler with the pressure container.

Next, the gas test device may perform a gas test by setting the temperature conditions and injecting the test gas into the pressure container, which has a predetermined number of fillers inserted into the interior space of the pressure container. The gas test may include a pressure cycling test, also referred to as pressure circulation test. In other words, the gas test may include a gas leakage test, a burst test, a repeated pressurization test, a gas permeability test, or any combination thereof.

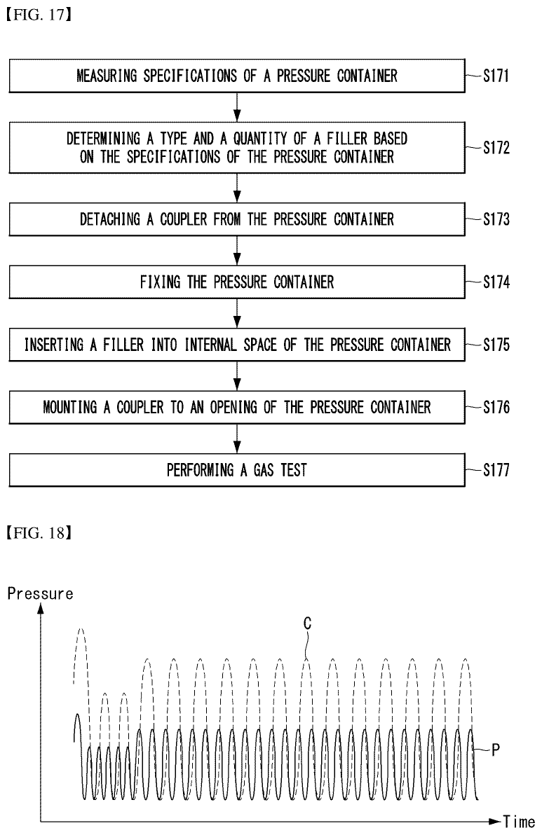

FIG. 18 is a view showing results in which the testing time of the pressure container test method according to the present exemplary embodiment and that of a conventional pressure container test method are compared.

As shown in FIG. 18, the test result P obtained by using the pressure container test method of the present exemplary embodiment shows that, despite using the same pressure container, the internal volume of the pressure container is reduced by approximately 40% by means of the inserted filler, so that the time required for each pressure cycle is shortened compared to the comparative example C, leading to an overall gas test time that is reduced by more than half.

More specifically, the comparative test results between the present exemplary embodiment (with filler) and the comparative example (without filler) are shown in Table 2 below.

TABLE 2

| Sample | Tank (w/filler) | | Tank (w/o filler) | |
|---|---|---|---|---|
| Volume | 175 L | (105 L) | 175 L | |
| Leak test | No leak | | No leak | |
| First permeation rate | 4.57 (9.9% compared | | 2.09 (4.5% compared | |
| (cc/hr/L) | to the limit) | | to the limit) | |
| Average test time | 54 min/cycle | (@20° C.) | 109 min/cycle | (@20° C.) |
| | 67 min/cycle | (@55° C.) | 91 min/cycle | (@55° C.) |
| | 224 min/cycle | (@−40° C.) | 979 min/cycle | (@−40° C.) |

| | | |
|---|---|---|
| Middle permeation rate | 6.37 (13.8% compared | 5.52 (12% compared |
| (cc/hr/L) | to the limit) | to the limit) |
| Internal inspection | No damage | No damage |
| Pressure cycling test | Pass | Pass |
| (Hydraulic) | | |
| Final permeation rate | 6.34 (13.8% compared | 5.28 (11.5% compared |
| (cc/hr/L) | to the limit) | to the limit) |
| Internal inspection | No damage | No damage |
| after cutting | | |

According to Table 2, the test results for the first permeation rate, the average test time, and the middle permeation rate demonstrate that in the GTR No. 13 test procedure, the present exemplary embodiment using a tank with filler (tank (w/filler)) and the comparative example using a tank without filler (tank (w/o filler)) show differences in the first permeation rate, but exhibit similar permeation performance in the middle permeation rate after a simple pressure cycling test.

In terms of the average test time, the present exemplary embodiment recorded 54 minutes per cycle at 20° C., whereas the comparative example recorded 109 minutes per cycle at the same temperature. This shows that the test time in the present exemplary embodiment is reduced by approximately 50% compared to the comparative example at 20° C.

Furthermore, the average test time at −40° C. in the present exemplary embodiment is 224 minutes per cycle, while in the comparative example it is measured to be 979 minutes per cycle. Thus, under a −40° C. environment, the test time of the present exemplary embodiment is reduced by approximately 77% compared to the comparative example.

Next, when considering the results for the middle permeation rate, the pressure cycling test using hydraulic pressure, and the final permeation rate, it is found that the difference between the middle and final permeation rates in the present exemplary embodiment is only 0.03, indicating virtually no leakage. This value is even lower than the 0.24 seen in the comparative example.

Moreover, internal inspections conducted before and after cutting the tanks revealed no physical damage in either the present exemplary embodiment or the comparative example.

Accordingly, the pressure container test method of the present exemplary embodiment demonstrates that by using fillers, gas test time may be reduced by up to 77%.

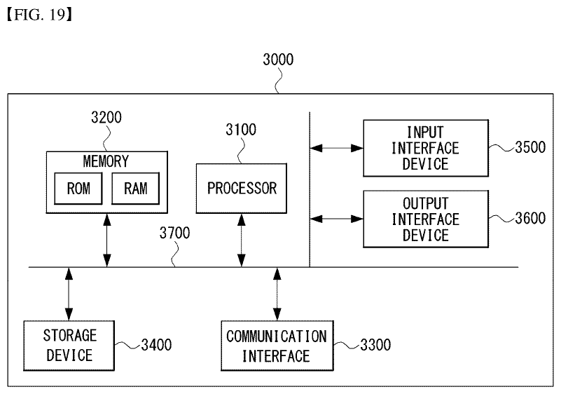

FIG. 19 is a schematic block diagram of a pressure container test device according to another exemplary embodiment of the present disclosure.

As shown in FIG. 19, the pressure container test device 3000 may be a communication device, a communication control device, and/or an electronic control device for performing gas test for a pressure container, and may have a structure similar to that of a generalized computing system, such as one that may be mounted in hydrogen fuel mobility platforms, dispensers, or charging stations, and functions as a communication device, communication control device, and/or electronic control device for gas testing of pressure containers. In a broad sense, the pressure container test device 3000 may correspond to the pressure container testing equipment described with reference to FIG. 1, but in a narrower sense, the pressure container test device 3000 may be configured to include only at least one electronic control device (e.g., the control device 700 in FIG. 1) for controlling the operation of components of the test equipment.

Although specific wiring relationships are omitted from the FIG. 19, in the pressure container test device 3000, a processor 3100 and a memory 3200 are electronically connected to each component, and the processor 3100 may control or manage their operation. For example, the processor 3100 may be connected to at least one of the filler insertion device 210, the coupler mounting device 220, the gas test device 230, the inspection device 240, the transfer device 400, and the robot 500, and may send or receive signals and data to/from them. Thus, the pressure container test device 3000 may perform at least part of any of the pressure container test methods described in the preceding exemplary embodiments.

The pressure container test device 3000 may include at least one processor 3100 and a memory 3200 that stores instructions for the processor to perform at least one step. At least some steps of the pressure container test method according to the present exemplary embodiment may be performed by the processor 3100 executing instructions loaded from the memory 3200.

Furthermore, the pressure container test device 3000 may include a communication interface 3300 for wireless communication, a storage device 3400, an input interface device 3500, and an output interface device 3600. Each component within the test apparatus 3000 may be interconnected via a bus 3700 for communication.

The processor 3100 may be a central processing device (CPU), a graphics processing device (GPU), or a dedicated processor configured to perform methods according to the present disclosure.

The memory 3200 and the storage device 3400 may each include at least one of a volatile or non-volatile storage medium. For example, the memory 3200 may include a read-only memory (ROM) and/or a random access memory (RAM).

A device including the processor 3100 according to this exemplary embodiment may be implemented as, for example, a communication-enabled desktop computer, a laptop, a notebook, a smartphone, a tablet PC, a mobile phone, a smartwatch, smart glasses, an e-book reader, a portable multimedia player (PMP), a handheld gaming console, a navigation device, a digital camera, a digital multimedia broadcasting (DMB) player, a digital voice recorder, a digital audio player, a digital video recorder, a digital video player, or a personal digital assistant (PDA).

The operations of the method according to an exemplary embodiment of the present disclosure may be implemented as a program or code readable by a computer and stored on a computer-readable recording medium. The computer-readable recording medium includes all types of recording devices in which information readable by a computer system is stored. Moreover, such a recording medium may store and execute a program or code in a distributed manner across computer systems connected via a network.

Additionally, the computer-readable recording medium may include hardware devices specifically configured to store and execute program instructions, such as a ROM (read-only memory), a RAM (random access memory), or a flash memory. The program instructions may include machine code generated by a compiler, as well as high-level language code executable by a computer through the use of an interpreter.

Some aspects of the present disclosure have been described in the context of a device; however, they may also be expressed in terms of a corresponding method, wherein blocks or devices correspond to method steps or features thereof. Conversely, aspects described in the context of a method may also be expressed as blocks, items, or features of a corresponding device. Some or all of the method steps may be performed by (or using) hardware devices such as microprocessors, programmable computers, or electronic circuits. In some exemplary embodiments, at least one of the most critical method steps may be carried out by such devices.

In some exemplary embodiments, a programmable logic device (e.g., a field-programmable gate array, FPGA) may be used to perform part or all of the functions of the methods described herein. In some exemplary embodiments, the FPGA may operate in conjunction with a microprocessor to perform one of the methods described herein. In general, it is desirable that such methods be carried out by hardware devices.

While the preferred exemplary embodiments of the present disclosure have been described above, those skilled in the art will understand that various modifications and alterations may be made without departing from the spirit and scope of the disclosure, as defined in the claims below.

1. A method for testing a pressure container for compressed hydrogen storage container, comprising:
inserting at least one filler into an internal space of a pressure container;
mounting a coupler to an opening of the pressure container in which the filler is inserted; and
performing a gas test on the pressure container in which the internal space is reduced in volume by the filler.

2. The method of claim 1, wherein the filler has a second length that corresponds to a first length of the internal space in a longitudinal direction of the pressure container and is smaller than the first length.

3. The method of claim 1, wherein in the inserting of the at least one filler, a predetermined number of fillers are inserted such that the predetermined number of fillers occupy 20% to 50% of a volume of the internal space.

4. The method of claim 1, wherein in the performing of the gas test, a pressure cycling test is performed at ambient and extreme temperatures.

5. The method of claim 1, further comprising: measuring specifications of the pressure container.

6. The method of claim 5, further comprising: determining at least one of a type or a quantity of the filler based on the specifications.

7. The method of claim 6, further comprising: transferring the pressure container to a position for inserting the filler.

8. The method of claim 7, further comprising: fixing the pressure container before the inserting of the filler.

9. The method of claim 7, further comprising: detaching a coupler from the pressure container before the inserting of the filler.

10. The method of claim 1, wherein the coupler comprises a check valve, a shut-off valve, and a thermally-activated pressure relief device.

11. A pressure container test device for testing a compressed hydrogen storage container, comprising:
at least one processor,
wherein the at least one processor causes the pressure container test device to perform:
inserting at least one filler into an internal space of a pressure container;
mounting a coupler to an opening of the pressure container into which the filler is inserted; and
performing a gas test on the pressure container with a reduced volume of the internal space.

12. The pressure container test device of claim 11, wherein the filler has a second length that corresponds to a first length of the internal space in a longitudinal direction of the pressure container and is smaller than the first length.

13. The pressure container test device of claim 11, wherein in the inserting of the filler, a predetermined number of fillers are inserted such that the predetermined number of fillers occupy 20% to 50% of a volume of the internal space.

14. The pressure container test device of claim 11, wherein in the performing of the gas test, a pressure cycling test is performed at ambient and extreme temperatures.

15. The pressure container test device of claim 11, wherein the at least one processor further causes the at least one processor to perform: measuring specifications of the pressure container.

16. The pressure container test device of claim 15, wherein the at least one processor further causes the pressure container test device to perform: determining at least one of a type and a quantity of the filler based on the specifications.

17. The pressure container test device of claim 16, wherein the at least one processor further causes the at least one processor to perform: transferring the pressure container to a position for inserting the filler.

18. The pressure container test device of claim 17, wherein the at least one processor further causes the at least one processor to perform: fixing the pressure container before the inserting of the filler.

19. The pressure container test device of claim 17, wherein the at least one processor further causes the at least one processor to perform: detaching a coupler from the pressure container before the inserting of the filler.

20. The pressure container test device of claim 11, wherein the coupler includes a check valve, a shut-off valve, and a thermally-activated pressure relief device.
